(19) United States
(12) Patent Application Publication
(10) Pub. No.: US 2011/0108661 A1
(43) Pub. Date: May 12, 2011

(54) SEGMENTED AIRCRAFT COMPRISING AN ENERGY MEDIUM

(76) Inventor: Bernd-Helmut Kroeplin, Berlin (DE)

(21) Appl. No.: 13/003,638

(22) PCT Filed: Jul. 28, 2008
(86) PCT No.: PCT/EP2008/059879

§ 371 Date: Jan. 11, 2011

(30) Foreign Application Priority Data
Jul. 11, 2008 (DE) 10 2008 002 939.4

(51) Int. Cl. B64B 1/58; B64C 11/00; B64B 1/20

(52) U.S. Cl. 244/25; 244/128; 244/65

(57) ABSTRACT

The invention relates to a segmented aerial vehicle with gasbags filled with an energy medium. It refers in particular to an aerial vehicle having interlinked gasbags and/or one big gasbag. This one gasbag or these interlinked gasbags are filled with an energy medium the specific weight of which is approximately the one of air.

The energy medium of the gasbags provides energy to the eccentrically placed controllable engines fixed at the segments. The vector thrust produced by the engines and by the vehicle's envelope under excess compression provide sufficient dynamic lift to have the proposed invention fly in a stable and controllable way all in carrying a defined payload,

Inside segmented interconnected airbags are placed interconnected segmented gasbags. The gas cells are filled with an energy medium as for example fuel gas (a mixture of propane and butane gases) and provide energy to the engines, which are fixed underneath the head segment and which drives an eccentrically placed pair of propellers generating a vector thrust.

The ventilator produces excess compression to the volume formed by the envelope, giving to the segmented aerial vehicle a flexible form stability which produces by interaction with the vector thrust a dynamic lift.

### DESCRIPTION

The invention relates to a segmented unmanned aerial vehicle equipped with gasbags.

It is known, that according to DE 100 53 775 A1 unmanned aerial vehicles can have disconnected gasbags integrated in interlinked envelope segments and which contain a lighter than air lift medium, for example helium.

The purpose of the invention is to operate an unmanned aerial vehicle by the gas carried along as drive propulsion gas.

To solve this task it is proposed to use a segmented unmanned aerial vehicle comprising the features of claim 1 and the respective sub claims.

Instead of having disconnected gasbags and envelope segments and thereby disconnected volumes, a segmented construction is used with connected volumes. The total volume is filled with a gas like energy medium having approximately the specific weight of air, thus providing the energy to operate the unmanned aerial vehicle. By a system of lockable and openable bulkheads linking the gasbags, the interlinked volumes can be modified.

Compared to the current state of the art, the problem of interlinked gasbags and/or of an end-to-end gasbag filled with a gaseous energy medium having the approximate specific weight of air is solved by a modified construction technique and by using an aligned energy medium for the unmanned aerial vehicle. The segments can be equipped with eccentrically placed, controllable propulsion systems being respectively powered with energy. The propulsion systems provide a thrust in combination with the compression charged envelope a dynamic lift allowing the described unmanned aerial vehicle to fly with a defined payload in a stable and controllable way.

The advantages of the invention are particularly substantial cost reductions concerning the material for the envelopes as well as the omission of separate receptacles for the energy supply. Thus the weight of the bulk structure is diminished allowing the set up of comparatively smaller dimensioned aerial vehicles that are by dynamic lift nevertheless able to fly in a stable and controllable way.

A particular embodiment of the invention will now be described by way of example only with reference to the accompanying drawings in which

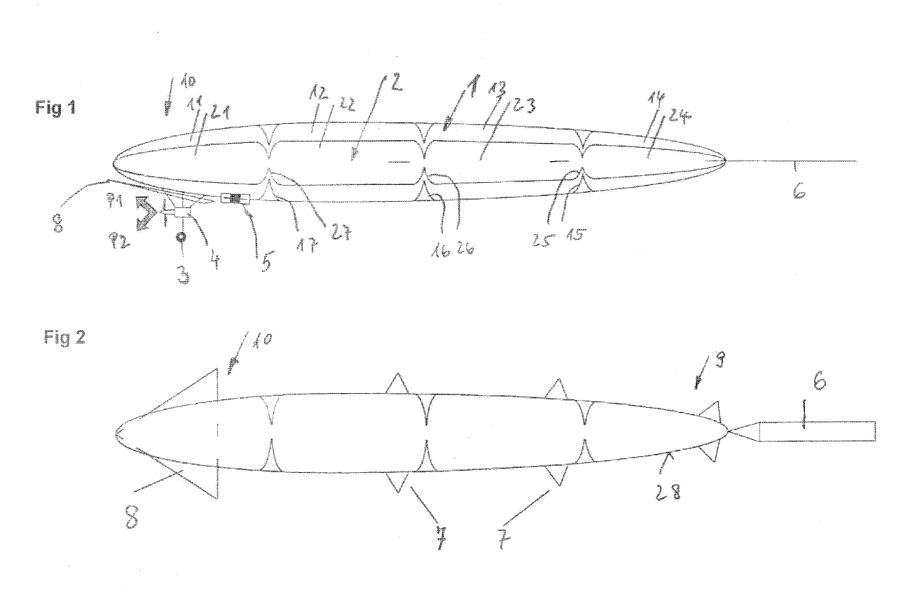

FIG. 1 is a first embodiment of a segmented unmanned aerial vehicle with energy medium in sidewise sectional view.

FIG. 2 is the embodiment as in FIG. 1 in top view.

FIG. 1 shows a preferred embodiment of a segmented aerial vehicle filled up with an energy medium in sectional side view.

Within segmented but interconnected air-filled bags 1,11-14 inside the envelope 28 of the aerial vehicle segmented interconnected gasbags 2,21-24 are located.

The gasbags 2,21-24 are designed by oppositely fixed constrictions 15-17 and constructive lateral constructions 25-27 within the airbags 1,11-14.

For example the gasbags can be filled with fuel gas (a mixture of propane and butane gases) as energy medium providing an engine 4 with energy. The engine 4 is placed under the head segment 10 of the aerial vehicle, for example, driving an eccentrically placed pair of propellers, causing a vector thrust as indicated by the arrows P1, P2 or otherwise.

The ventilator 5 creates excess compression of the volume formed by the envelope 28, giving to the segmented aerial vehicle a flexible shape stability and respectively producing a dynamic lift in interaction with the vector thrust of P1, P2. To assure a safe landing an undercarriage 3 is provided.

FIG. 2 shows the embodiment of a segmented aerial vehicle with energy medium as proposed by the invention in top view with fixed wings 7 and a delta wing 8 underneath the head segment 10 of the aerial vehicle. The wings increase the dynamic lift. The wings 7 and the delta wing 8 may be taken off alternatively. At the rear 9 of the vehicle a banner 6 can be placed to further improve the flight stability of the vehicle.

1. Unmanned aerial vehicle being composed of inner gasbags holding the energy medium, of separate outer air-filled gasbags which are fully embedding the inner gasbags and of a flexible outer envelope enclosing the aforementioned bag systems,
wherein the interlinked outer air-filled bags (1; 11-14) and the interlinked end-to-end volume inner gasbags (2; 21-24) are designed as segments (10) based on a system of by lateral construction formed bulkheads (15-17) of the air-filled bags respectively by a system of oppositely placed by lateral construction formed bulkheads (25-27) of the gasbags (2; 21-24).

2. Unmanned aerial vehicle in accordance with claim 1,
wherein the segments (10) of the inside placed gasbags (2; 21-24) are separable from each other by a system of bulkheads (25-27) linking the gasbags which can be opened and closed so that the interlinked volumes can be modified.

3. Unmanned aerial vehicle in accordance with claim 1,
wherein the engine (4) is placed with the head segment (10) powering at least one eccentrically placed thrust producer as for example a pair of propellers.

4. Unmanned aerial vehicle in accordance with claim 1,
wherein the inside placed gasbags (2; 21-24) are to be filled with a gas as energy medium, to provide with energy at least one engine fixed to at least one segment (10).

5. Unmanned aerial vehicle in accordance with claim 1,
wherein the volume of the gasbags (2; 21-24) can be filled with an energy medium having approximately the specific weight of air.

6. Unmanned aerial vehicle in accordance with claim 1,
wherein the volume of the gasbags (2; 21-24) can be filled with air.

7. Unmanned aerial vehicle in accordance with claim 1,
wherein the volume of the gasbags (2; 21-24) can be filled in parts with an energy providing fuel gas as energy medium and/or in parts with a lighter than air lift providing gas and/or in parts with air.

8. Unmanned aerial vehicle in accordance with claim 1,
wherein a dynamic lift is producible by the outer compression charged envelope (28) and/or by at least one or more wings (7) being placed underneath or on top, single or pair wise, of at least one of the segments (10), and by the shear (P1, P2) of respective shear producers.

9. Unmanned aerial vehicle in accordance with claim 1,
wherein eccentrically placed propulsion systems are placed underneath and/or on top of at least one of the segments (10; 2; 21-24). The propulsion systems work on the basis of the gaseous energy medium that is contained in the inner gasbags (2; 21-24) and/or on the basis of a fluid or compact, commercially available energy medium placed in tanks.
